(19) United States
(12) Patent Application Publication
(10) Pub. No.: US 2010/0181473 A1
(43) Pub. Date: Jul. 22, 2010

(54) METHOD AND APPARATUS FOR THE ANALYSIS OF SAMPLES

(76) Inventors: Paul William Miles Blenkinsopp, Bitterne (GB); Rowland Hill, Gerrards Cross (GB)

Correspondence Address: Setter Roche LLP, P.O. Box 780, Erie, CO, 80516, US

(21) Appl. No.: 12/670,063

(22) PCT Filed: Jul. 21, 2008
(86) PCT No.: PCT/GB08/02501

§ 371 Date: Jan. 21, 2010

(51) Int. Cl. H01J 49/26; H01J 49/04

(52) U.S. Cl. 250/282; 250/288

(57) ABSTRACT

The present invention relates to an apparatus and method for the analysis of ions in a mass spectrometer comprising; a means to remove material from the sample at a defined specific point, a means to change either discretely or continuously the said defined point of material removal, at least one ionisation means, at least one ion accelerator, at least one energy selective means, a time focus means, a pulse bunching means and a detection means. Said invention allows the mass of an to be analysed with respect to multiple positions on a sample of a material providing a method and apparatus that allows the effective three dimensional mapping of the sample in terms of its constituent parts, their corresponding distribution in those three dimensions in relation to each other and other points of interest on the said sample and also to retain important chemical information by permitting the analysis of whole and intact molecules present on the surface of or within the material sample.

### BACKGROUND OF THE INVENTION

In 1910, the British physicist J. J. Thomson observed that positive ions and neutral atoms were released from a solid surface when bombarded with ions. Later, in 1949, improvements in vacuum pumps and associated technologies enabled the first prototype experiments on Secondary Ion Mass Spectrometry (SIMS) to be carried out by Herzog and Viehböck at the University of Vienna in Austria. Since the earliest days, the potential for SIMS to be a very powerful analytical technique has been recognised but has not yet realised its fullest potential. In the intervening years to now, the SIMS technique has expanded to encompass many different and useful methods of material analysis, many of which are not achievable by other analytical methods. These include 2 dimensional chemical mapping or imaging, depth profiling and more recently the capability to obtain detailed chemical and compositional information from biological and bio-chemical materials. The range of probes of the material has also increased to include not only an elementary ion probe such as Argon or Oxygen, but also the removal of material by large molecular clusters such as C60, fast atom bombardment and laser ablation. Other improvements to the SIMS technique have included improved mass and spatial resolution, the possibility to measure non-ionised material removed from the sample by post ionisation, the so called Secondary Neutral Mass Spectrometry (SNMS) that permits analysis of the removed material in a mass spectrometer and the ubiquitous advances in computing technology that has lead to a vast array of instrument control, data capture and analysis facilities.

Several methods of analysis in a mass spectrometer are used for SIMS. These include mass separation by using powerful electromagnets, the so called Magnetic Sector instrument, mass separation by the application of Radio Frequency (RF) electric fields, the so called Quadrupole and the Ion Trap, and the separation of masses by their arrival time at a detector, the technique known as Tine of Flight (ToF).

One of the key aims to improving the performance and analytical capabilities of SIMS (and SNMS) has been to achieve a better utilisation of the removed material from the sample in the analysis. Both the Magnetic Sector and Quadrupole based instruments can generally only measure a single mass at any one time and all other masses are effectively thrown away even though they may be of interest. In order to measure more than one mass, the Mass Spectrometer must be switched between masses to monitor them sequentially and hence the utilisation of that sample is not optimised. Additionally, both Magnetic Sector and Quadrupole mass analysers have quite severe practical limitations on the upper range of masses that can be effectively measured. In contrast, it is well known that ToF mass analysers can not only analyse all the masses that are removed in a short time period but that they, theoretically at least, have an unlimited mass range which makes them very suitable for use with biochemical and biological samples, which frequently contain high molecular weight materials such as peptides and proteins. This became very important with the introduction of Matrix Assisted Laser desorption and Ionisation (MALDI) which led to a revolution in chemical and bio chemical analysis. It has been a goal to apply the ToF technique to SIMS, but a number of technical problems including the requirement to provide a pulsed source of ions for the ToF analyser (which is rather simply achieved in MALDI by using an intense pulse of UV laser light) to make the ToF analyser effective. Lasers have been used in SIMS analysis in combination with ToF with limited effectiveness, partially due to the lack of depth control achievable in the probing of the sample surface.

In a typical SIMS analysis, a directed beam of suitable ions, the primary beam or ion probe, is directed at the sample surface and the chemical analysis of ions sputtered from the surface and near surface volumes is carried out in a magnetic Sector or Quadrupole mass analyser or Mass Spectrometer (MS). The primary beam can usually be focussed to form a desired spot size and controllably, continuously and repeatably scanned over a specified region on the surface of the sample to provide a constant stream of secondary ions for analysis in the MS. This is carried out over a relatively small area of 10's to 100's of microns and covering relatively shallow volumes below the surface, often to a depth of a few microns with a high spatial resolution.

In order to use ToF for this type of analysis, a pulsed primary beam has previously been used. However, this technique, whilst offering some usefulness in SIMS analysis, has a limited resolution of the spectrometer which links directly to the duration of these primary ion beam pulses which therefore need to be very short, often less than 10 ns, sometimes 1 ns. Such short pulses are only produced at the expense of spatial resolution, which is critical in imaging applications. Short pulsing also results in a vastly reduced primary beam current and slows down the rate of data acquisition as a result of the poor duty cycles which follow from the need for consecutive pulses of the primary beam not to overlap in the ToF analyser. Although all the secondary ions in a pulse can be measured and the mass range is greatly improved, the time taken for analysis is very much longer than that for SIMS carried out using a continuous beam. There are also other factors associated with the differences in analytical results arising from the use of pulsed primary beam when compared to a continuous primary beam that make the use of a continuous primary beam highly desirable.

One alternative to this is to use an orthogonal ToF MS in which a continuous secondary beam is formed and then pulses are extracted from it by an intermittent electric field which is orthogonal to the direction of the secondary ion beam. This arrangement overcomes some of the disadvantages of the conventional ToF system, though this is at the expense of transmission of ions through the ToF analyser.

The current invention overcomes many of these limitations making ToF SIMS with a continuous primary beam realisable by means of using a charged particle buncher (U.S. Pat. 7,045,702 B2) applied to the secondary ions thereby combining and optimising the use of the continuous primary ion beam and pulsed secondary ions in a ToF type arrangement with a high sample utilisation and high repetition rate providing a unique, very effective and powerful analytical tool. A version of the multiple plate buncher has been used with Electrospray Ionisation (ESI) and MALDI ion sources for organic mass spectrometry. In these applications ions are generated from a liquid sample or from a solid sample comprising an analyte material dispersed in a MALDI matrix. Neither of these techniques can produce high spatial resolution images of real solid samples.

In a preferred embodiment, a sample is generally supported inside a vacuum chamber on a precision motion stage. An ion source and optical column are mounted on the vacuum chamber to direct a scanning ion beam at the sample. A range of beams may be used that have the properties of different energies, ion mass, ion charge state and quality of focus tailored to the type of analysis required. This primary ion beam impacts the sample surface and causes material to be ejected from the sample in the form of atoms, molecules or molecular fragments, some of which are ionised. The ionised particles, the secondary ion beam, are then drawn into the MS through an aperture in an extraction electrode carrying a suitable potential to attract the ions. In secondary neutral mass spectrometry (SNMS), a similar arrangement is used, except that some method of post-ionisation is used to ionise neutral particles after they are ejected from the surface. The secondary ion beam enters the analyser of the mass spectrometer in discrete pulses so that the time of flight measurement is made with respect to a starting time reference for each pulse.

### DESCRIPTION OF FIGURE

An apparatus and method for the analysis of solids and solidified materials are now described by way of example by means of a preferred embodiment only and by reference to the accompanying drawing of which;

FIG. 1 shows a preferred embodiment in schematic form and illustrates a configuration of this device in a SIMS instrument. All of the items in the drawing are contained within a vacuum chamber.

### DETAILED DESCRIPTION

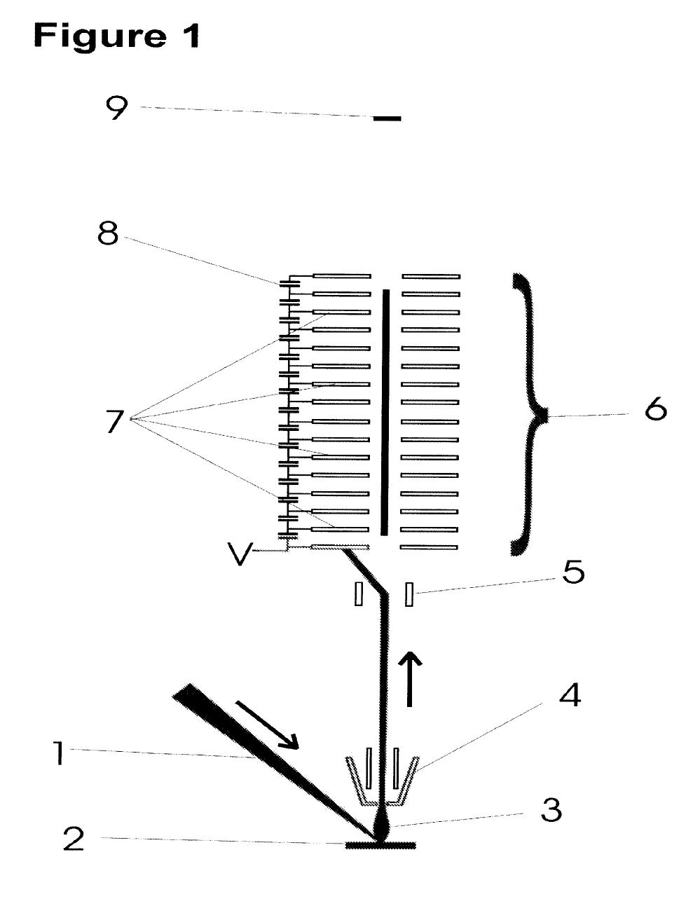

A preferred embodiment as shown in FIG. 1 is now described.

A continuous primary beam (1) is incident on the sample (2), generating a continuous secondary ion beam (3), roughly collimated by the extraction optics (4). This beam is chopped into discrete pulses by a set of deflection plates (5) at the entrance to the multiple plate buncher assembly (6). The timing of the switching of the deflection plates (5) is adjusted such that close to the whole length of the buncher (6) is filled by one pulse in the mass range of interest, as shown in the figure. The buncher assembly consists of a set of electrodes (7) in the form of plates with aligned holes along the beam path. These plates are connected by a chain of capacitors (8) such that a high voltage (V) applied to the rear plate results in a series of reducing voltages applied to plates further forward. At the instant when a secondary beam pulse is contained within the buncher, a high voltage pulse is applied to the buncher plates (7). With careful adjustment of the capacitor values, the buncher forms a time focus for the pulse at a point (9) which is a chosen distance beyond the exit of the buncher.

An ion detector positioned at this time focus enables the arrival time of the ions to be recorded and this is subsequently translated into a value for the mass to charge (m/z) ratio. Alternatively, the ions can be allowed to pass through it into a further ToF analyser to extend the mass resolution of the system. With this latter configuration, a set of deflectors can be positioned at the time focus for mass range selection.

In a typical set-up, the buncher operates on a 100 microsecond cycle, in which the pulse formation takes 90 microseconds with the ejection of the pulse to the time focus taking 10 microseconds. Thus, only 10% of the beam is lost in the sampling process. The rate of data acquisition is a function of duty cycle, the ratio of ‘beam-on’ time to real time. With the combination of continuous primary ion beam and multiple plate buncher, the duty cycle is 0.9, compared with the 0.0001, an increase of a factor of approx. 9,000 over a conventional ToF SIMS in high mass resolution mode. This is achieved without sacrificing the ToF advantages of being able to analyse all masses contained in the pulse, spatial or mass resolution and the extended mass range capability when compared to magnetic field or RF separation of masses. The combination of SIMS or SNMS and the multiple plate buncher is particularly suitable when primary beams of low brightness or high mass are used as these are more difficult to fast-pulse without loss of focus. Used in conjunction with a second ToF analyser, the buncher gives the facility for analysis of fragments in a further Mass Spectrometer in a process known as MSⁿ (where n is an integer greater than 1) in which molecular ions in the secondary beam are fragmented near the first time focus. This new analysis technique will be a powerful tool for analysis of complex organic structures. For example, it will be capable of producing molecular distribution data for a volume inside a single cell. Moreover, such data will be acquired within a timescale of a few minutes instead onf the several hours or even days that has previously typically had to be contemplated.

It will also provide the facility for superior performance in terms of more traditional SIMS analysis on solid materials such as semiconductors, metals and polymers, for example, in some applications.

1. An apparatus for the analysis of ions in a mass spectrometer comprising:
a means with which to support a suitable solid or solidified sample inside a vacuum chamber;
a means to controllably remove material from said solid or solidified sample at a defined specific point; and
a means to change, either discretely or continuously, the said defined point of material removal; and
at least one ionisation means; and
at least one ion acceleration means; and
at least one ion directing means; and
a pulse bunching means; and
a detection means; and
a means of instrument control and data acquisition.

2. An apparatus as claimed in claim 1 where the said removal means is by charged particles or ions.

3. An apparatus as claimed in claim 1 where the said removal means is by fast atom or molecule bombardment.

4. An apparatus as claimed in claim 1 where the said removal means is by continuous wave (CW) laser primary beam.

5. An apparatus as claimed in claim 1 where the primary beam is comprised of any suitable ions with either a positive or negative charge state.

6. (canceled)

7. An apparatus as claimed in claim 1 where the primary beam is scanned across a stationary sample in a controlled and predefined manner.

8. An apparatus as claimed in claim 1 where the primary beam is stationary and the sample support means comprises a precision motion stage which can be moved in a controlled and well defined manner with respect to the stationary primary ion beam.

9. An apparatus as claimed in claim 1 where both the sample support means and the primary ion beam may be moved with respect to each other in a controlled and well defined manner.

10. An apparatus as claimed in claim 1 where the means of ionisation is the primary beam.

11. An apparatus as claimed in claim 1 where the means of ionisation is by means of a post particle removal ionisation source.

12. An apparatus as claimed in claim 1 where the secondary ions are passed through an energy filter prior to entering the pulse bunching means.

13. An apparatus as claimed in claim 1 for high spatial and mass resolution imaging with chemical analysis which uses a primary ion beam incident upon a sample to generate secondary particles which are analysed in a mass spectrometer using a multiple plate buncher, which comprises a set of at least 6 plates spaced along the secondary beam path with holes in the plates to allow the beam's passage through the plates, wherein a nonlinear potential is applied across the plates to form a time focus for secondary beam pulses.

14. An apparatus as claimed in claim 1 where the secondary ions are detected at the time focus.

15. An apparatus as claimed in claim 1 where the secondary ions are transmitted through the time focus into a further mass analyser.

16. An apparatus as claimed in claim 1 where a beam blanking device is placed close to the time focus to select a mass range for onward transmission.

17. An apparatus as claimed in claim 1 where the secondary ions are subjected to collisional fragmentation prior to transmission into a further mass analyser.

18. An apparatus as claimed in claim 1 where the secondary ions are subjected to fragmenting exciting radiation prior to transmission into a further mass analyser.

19. An apparatus as claimed in claim 1 where the secondary ion beam passes through a region where gas pressure is elevated above the normal vacuum of the system prior to entering the multiple plate buncher, in order to cool the internal states of the secondary ion, focus them or reduce their kinetic energy spread.

20. A method for rapidly acquired high spatial and high mass resolution imaging with chemical analysis which uses a primary means of removal of particles from a solid or solidified surface where ions are subsequently generated which are then directed to a mass spectrometer using a multiple plate buncher comprising a set of at least 6 plates spaced along the secondary beam path with holes in the plates to allow the beam's passage through the plates, wherein a nonlinear potential is applied across the plates to form a time focus for secondary beam pulses which are subsequently detected at the time focus of the buncher.

21. A method as claimed in claim 19 where the secondary ions are submitted to selective collisional fragmentation prior to transmission into a further mass analyser providing MS/MS or higher capability.

22-23. (canceled)
